(19) United States
(12) Patent Application Publication
(10) Pub. No.: US 2005/0135402 A1
(43) Pub. Date: Jun. 23, 2005

(54) Data transfer apparatus

(75) Inventors: Kenichi Kawaguchi, Kobe-shi (JP); Yoshiteru Mino, Hirakata-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/998,136

(22) Filed: Nov. 29, 2004

(30) Foreign Application Priority Data
Dec. 2, 2003 (JP) 2003-402708

(51) Int. Cl. H04J 3/26

(52) U.S. Cl. 370/432

(57) ABSTRACT

A buffer is provided between an image processor and image I/O unit and a shared memory to be accessed by those units in common, and the buffer is controlled so as to be used only for a specific access, and data transmission to the shared memory is also controlled. With respect to a single transmission request from the image processor and a burst transmission request from the image I/O unit, a selector is controlled such that the single transmission data is retained in the buffer and that the burst transmission to the shared memory is executed.

### BACKGROUND OF THE INVENTION

1. Field of the Invention

The present invention relates to a data transfer apparatus. More particularly, the present invention relates to a data transfer apparatus capable of transferring the data between a plurality of functional units and a shared resource accessible in common from the plurality of functional units, with a fewer number of hardware devices.

2. Description of the Prior Art

For executing data processing, various systems employ a shared resource to which a plurality of functional units can make access in common.

A first example is a graphic system in which a frame memory is shared. Some of such graphic systems are designed such that a rendering processor writes image bit map data in a specific region of the frame memory, and a video controller periodically reads out the frame memory. In this case, the rendering processor performs an image generation for expressing an object such as a line or a polygon. Accordingly, the data is to be transferred to a specific region in the frame memory. On the other hand, the video controller executes a processing of the object and a background. Accordingly, when accessing the frame memory for data transmission, the video controller reads out a line unit of a display screen or an entirety of the frame memory. Therefore, the data access unit from the rendering processor to the frame memory is a single to several words, while the data access unit from the video controller to the frame memory constitutes a data transmission of tens to hundreds of words.

A second example is a bus bridge system provided with a memory on a bus bridge, to which a device on a plurality of buses can make access. Such memory serves as a data buffer between a bus and another. A plurality of data processors is connected to each bus, and processing data are generated in different units. Accordingly, an access cycle and access unit for the memory can constitute various combinations depending on a data processing unit of the respective bus system or a frequency of each bus.

A third example is a bus controller, in which a plurality of CPU cores or a CPU core provided with a plurality of I/O, and an internal DMA controller is connected to a master port, and an I/O of an interface with a peripheral I/O is connected to a slave port. The CPU core requests, when provided with a cache, the bus controller to transfer the data in a cache line size unit, and requests the bus controller to transfer in a word unit when controlling the peripheral I/O. When transferring data of a larger scale, the DMA controller is set for transmission of a plurality of data, and requests the bus controller to transfer the data of a unit of the plurality of words.

These systems have the following drawback in common. When a plurality of functional units is to perform a data transmission to a shared resource, in the case where the shared resource to receive the data only accepts the data transmission from a functional unit that has the access ownership, other functional units that do not have the access ownership cannot execute the data transmission, and therefore the functional units cannot continue the data processing. Accordingly the performance of the system is degraded, sometimes even below a specified performance level, in which case the system becomes no longer operable.

For the purpose of solving this problem, a data transfer apparatus which efficiently performs a data transmission between a plurality of functional units and a shared memory has been proposed as shown in FIG. 7 (for example, JP-A Laid Open No.H11-250228, pp. 3-4, FIG. 1). In this data transfer apparatus, one of the plurality of functional units is an image processor, and the shared resource to be accessed in common is a memory.

In FIG. 7, reference numeral 1 designates the data transfer apparatus. Numeral 2 designates the image processor working as one of the functional units. Numeral 3 indicates an image I/O unit working as one of the functional units. Numeral 4 indicates a shared memory, corresponding to the shared resource. Numeral 5 designates a video signal generator. Numeral 6 designates a monitor.

In the data transfer apparatus 1, an interface 100 controls a data transmission with the image processor 2. Another interface 101 controls a data transmission with the image I/O unit 3. A buffer 102 temporarily retains data being transferred between the image processor 2 and the shared memory 4. A buffer 103 temporarily retains data being transferred between the image I/O unit 3 and the shared memory 4. A selector 104 selects either an output of the buffer 102 or an output of the buffer 103, and connects the output to the shared memory 4. An arbiter 105 selects which data to transfer according to priority, when the image processor 2 has requested a data transmission between the buffer 102 and the shared memory 4, or when the image I/O unit 3 has requested a data transmission between the buffer 103 and the shared memory 4. The control unit 106 controls data transmission between either of the buffer 102 or the buffer 103 and the shared memory 4, according to a transmission request selected by the arbiter 105.

In the shared memory 4, a region 401 is used for image processing, and a region 402 is used for inputting/outputting an image. And a data transmission between the image processor 2 and the shared memory 4 is divided into a data transmission between the image processor 2 and the buffer 102, and a data transmission between the buffer 102 and the shared memory 4. Likewise, a data transmission between the image I/O unit 3 and the shared memory 4 is divided into a data transmission between the image I/O unit 3 and the buffer 103, and a data transmission between the buffer 103 and the shared memory 4.

The image processor 2 makes a transmission request from the shared memory 4 to the buffer 102 in advance, and processes the data from the buffer 102. The image I/O unit 3 makes a transmission request from the shared memory 4 to the buffer 103 in advance, and processes the data from the buffer 103.

As described above, the data transfer apparatus shown in FIG. 7 is provided with the buffers 102, 103 for each of the plurality of functional units, namely for the image processor 2 and the image I/O unit 103 respectively. Accordingly, the plurality of functional units can execute the functions in parallel with respect to a data transmission to the shared memory 4, within an upper limit determined by a capacity of the buffer.

However, the prior art shown in FIG. 7 still has the following drawback.

Firstly, since the buffer is provided for each of the plurality of functional units, the hardware scale inevitably becomes larger. Also, in the case where a unit of transmission from a specific functional unit to the buffer is primarily of a considerably lower scale than a capacity of the buffer, or accessing frequency is low, working efficiency of the buffer corresponding to the specific functional unit is degraded.

Secondly, since a data transmission between a plurality of functional units and a shared memory accessed by the plurality of functional units is always performed via a buffer, an overhead emerges when making an access, which inhibits making a rapid access.

### SUMMARY OF THE INVENTION

It is an object of the present invention to solve the foregoing problem incidental to the prior art, by providing a data transfer apparatus capable of optimizing a hardware scale of a buffer and improving working efficiency of the buffer.

It is another object of the present invention to provide a data transfer apparatus capable of achieving a high-speed access between a plurality of functional units and a shared resource to be accessed in common.

For achieving the foregoing objects, the present invention has focused on coexistence of a single transmission and a burst transmission as a transmission mode to the shared resource, in a data processing system provided with a plurality of functional units.

A first aspect of the present invention provides a data transfer apparatus for receiving an input of transmission data output by a plurality of functional units and outputting the transmission data to a shared resource to be accessed in common by the plurality of functional units, which is provided with a buffer accessible in common from the plurality of functional units for a selective connection, for performing the data transmission to the shared resource to be accessed in common by the plurality of functional units. The data transfer apparatus is also provided with a path through which to transfer the data to the shared resource via the buffer, and a path through which to transfer the data to the shared resource without intermediation of the buffer.

In other words, this data transfer apparatus comprises a buffer; first data selecting means which selects the data output by the plurality of functional units and outputs the data to the buffer; second data selecting means which selectively outputs the data output by the plurality of functional units and the data output by the buffer; and data transmission control means which outputs the data of the second data selecting means and transfers the data to the shared resource.

In this case, it is preferable that, when the second data selecting means is selectively outputting the data from a functional unit among the plurality of functional units, the first data selecting means selectively outputs to the buffer the data from another functional unit than that from which the second data selecting means is selectively outputting the data among the plurality of functional units.

In the data transmission from the plurality of functional units to the shared resource, the transmission path is switched according to the transmission mode in the case where the plurality of functional units is requesting a different data transmission mode. In the present invention, it is decided whether a data transmission request is for a transmission carrying data of a minimum unit word (one word) per transmission or a transmission carrying data of a plurality of words per transmission, so that only the data related to the transmission carrying data of a minimum unit word per transmission is retained in the buffer, while the data related to the transmission carrying data of a plurality of words per transmission is transferred to the shared resource. The minimum unit word varies according to the system.

Accordingly, in this data transfer apparatus for example, when transferring only the data of a minimum unit word per data transmission cycle from the functional unit, the first data selecting means selectively outputs the data of the functional unit to the buffer.

Also for example, when executing both a data transmission only carrying the data of a minimum unit word per data transmission cycle from one of the plurality of functional units, and a data transmission carrying the data of a plurality of words per data transmission cycle from another of the plurality of functional units, the first data selecting means selectively outputs the data related to the transmission only carrying the data of a minimum unit word, to the buffer with priority.

Such examples include a case where a transmission data bus width is one word at the minimum unit word, and a case where block data of a minimum transmission size is one word when outputting the transmission size with the transmission data. Here, the transmission of data of one word per transmission is generally called a single transmission, and the transmission of data of a plurality of words a burst transmission.

According to the present invention, the number of necessary buffers is defined by a number of requests for a transmission carrying data of a minimum unit word per transmission, among the data transmission requests from the plurality of functional units. Accordingly, a buffer capacity can be reduced compared with a case where the data transmission request is for a transmission to the shared resource and each of the plurality of functional units is provided with a buffer.

The data transfer apparatus according to a second aspect of the present invention decides whether a data transmission request from a functional unit is for a transmission to the shared resource or a transmission from the shared resource, and switches the destination of a first data transmission to the buffer in the case where a second data transmission from the shared resource is requested by another functional unit during the first data transmission from the functional unit to the shared resource, thus to execute the second data transmission. In this case, not only the single transmission data but also the burst transmission data are temporarily retained in the buffer.

Accordingly, in this data transfer apparatus, the data transmission control means controls the data transmission from the second data selecting means to the shared resource, as well as the data transmission from the shared resource to the plurality of functional units. And when the plurality of functional units respectively request data transmission from the shared resource as well as data transmission to the shared resource, the first data selecting means selectively outputs to the buffer the data transferred from the plurality of functional units requesting the data transmission to the shared resource, and the data transmission control means transfers the data from the shared resource with priority.

The present invention makes it possible to accept a request for data transmission from the shared resource by a functional unit, even while executing a data transmission from another functional unit to the shared resource.

Also, the data transfer apparatus according to a third aspect of the present invention controls so as to transfer all the data retained in the buffer to the shared resource when a specific access is started by a functional unit, so that no data is left in the buffer when the access has finished. Also, the data transfer apparatus makes a specific access from a functional unit as well as an access from another functional unit to the shared resource.

In other words, the data transfer apparatus comprises a first register accessible from the plurality of functional units, and when one of the functional units starts an access to the first register, the data transmission control means detects the start of the access to the first register, and controls such that the data retained in the buffer is transferred to the shared resource with priority, and the access to the first register is finished once the transmission of the data retained in the buffer has finished.

The present invention assures that no written data remains in the buffer with respect to writing by a specific functional unit to the shared resource, when the plurality of functional units looks up a data processing result, and eliminates the need to make access to the shared resource in order to confirm that the data has been transferred to the shared resource. The shared resource is accessible from another functional unit. Therefore, it becomes possible to effectively utilize the transmission band width of the shared resource.

Here, it is preferable that the data transfer apparatus comprises an interrupt signal generating means, which activates an interrupt signal to another functional unit than that which has made the register access, once the access to the first register has finished.

Also, in the data transfer apparatus according to a fourth aspect of the present invention, the buffer retains, when retaining data, access information that constitutes a pair with the data. The access information includes address for a requested transmission from a functional unit, and identification information for identifying the functional unit that has made the transmission request. The data transfer apparatus compares the access information in the data transmission request and the access information retained in the buffer, when a functional unit has made a data transmission request but the buffer has data yet to be transferred to the shared resource, to thereby control the data transmission sequence.

A first way to control is transferring the data retained in the buffer with priority to the shared resource, in the case where the access information is the transmission address, and the transmission address in the data transmission request matches the transmission address retained in the buffer.

A second way to control is transferring the data retained in the buffer with priority to the shared resource, in the case where the access information is the transmission address, and an address region matches upon comparison of the address information by a register provided for such comparison.

A third way to control is transferring the data retained in the buffer with priority to the shared resource, in the case where the access information is the identification information for identifying the functional unit that has made the transmission request, and the functional unit requesting the data transmission and the functional unit that is the transferring party of the data retained in the buffer are identical.

Accordingly, in the data transfer apparatus, the buffer retains at least one transmission address in a pair with the transmission data, and a comparator is provided which compares a transmission address retained in the buffer and the transmission address requested by a functional unit so as to output a match information, and the data transmission control means further inputs the match information, so as to transfer the data from the buffer to the shared resource with priority until the match information is no longer active, in the case where the functional unit is requesting either the data transmission from the shared resource or the data transmission to the shared resource and the match information is active.

In the above configuration, the data transfer apparatus may comprise a second register, which determines a selection of a part of the transmission address, and the comparator may compare the part of the address and the transmission address requested by the functional unit.

Alternatively, in the data transfer apparatus, the buffer may retain a first identification information of the functional unit that has output the transmission data in a pair with the transmission data, and a comparator is provided which compares the first identification information retained in the buffer and a second identification information of the functional unit requesting the transmission so as to output a match information. And the data transmission control means further inputs the match information, so as to transfer the data from the buffer to the shared resource with priority until the match information is no longer active, in the case where the functional unit is requesting either the data transmission from the shared resource or the data transmission to the shared resource and the match information is active.

The data transfer apparatus according to a fifth aspect of the present invention is provided with address decoding means for dividing the address toward the shared resource into specified size regions, so as to generate an output control signal according to the address region.

In other words, the data transfer apparatus comprises a plurality of shared resources, which are respectively mapped in a different address region, and address decoding means which decodes the transmission address output by the second data selecting means. The data transmission control means controls the data transmission to the shared resource designated by the address decoding means, among the plurality of shared resources.

The present invention enables connection of a plurality of different shared resources, and connection of a device of a different transmission mode in each address region.

As described above, the data transfer apparatus according to the present invention is provided with a buffer between a plurality of functional units and a shared resource to be accessed in common by the plurality of functional units, and controls such that the buffer is used only for a specific access. Accordingly, a buffer capacity can be reduced compared with a case where the data transmission request is for a transmission to the shared resource and each of the plurality of functional units is provided with a buffer. In other words, by not providing the buffer for an exclusive use by the functional units, the hardware scale of the data transfer apparatus can be reduced.

Also, in case of a system in which the functional units make the data transmission request in different transmission units or in different transmission frequencies, it is possible to maintain the data transmission efficiency to the shared resource despite utilizing the buffer in common, and to improve a utilization efficiency of an entirety of the buffer of the data transfer apparatus. Further, the sequentiality of the data in an access to the shared resource can be assured by adopting the shared use of the buffer by the plurality of functional units. Also, switching the output control to the shared resource according to the address to the shared resource enables connection to the plurality of functional units and the plurality of shared resources.

### BRIEF DESCRIPTION OF THE DRAWINGS

FIG. 1 is a block diagram showing a configuration of a data transfer apparatus according to a first embodiment of the present invention.

FIG. 2 is a block diagram showing a configuration of a data transfer apparatus according to a third embodiment of the present invention.

FIG. 3 is a block diagram showing a configuration of a data transfer apparatus according to a fourth embodiment of the present invention.

FIG. 4 is a block diagram showing a configuration of a data transfer apparatus according to a fifth embodiment of the present invention.

FIG. 5 is a block diagram showing an internal configuration of a selector 107 of the data transfer apparatus according to the present invention.

FIG. 6 is a block diagram showing an internal configuration of a buffer 108 and a comparator unit 114 of the data transfer apparatus according to the present invention.

FIG. 7 is a block diagram showing a configuration of a conventional data transfer apparatus.

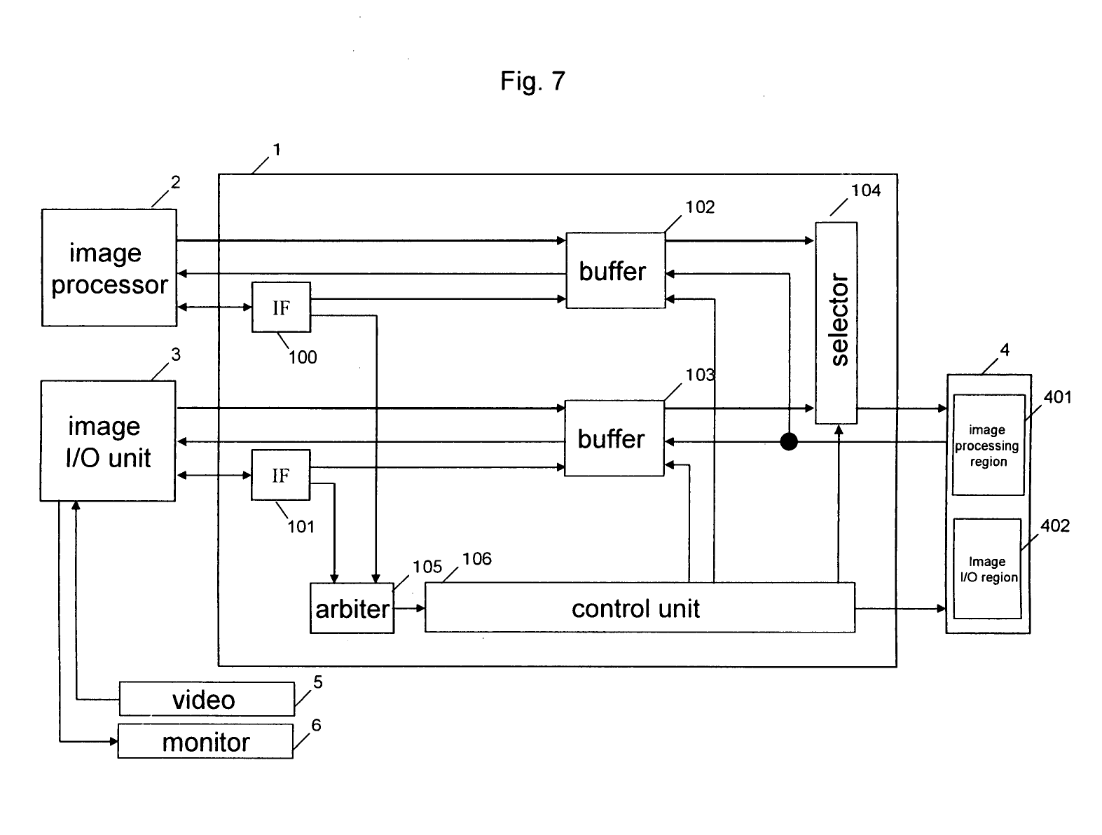

FIG. 8 is a timing chart showing an operation timing of a single write transmission during a burst write transmission in a conventional data transmission apparatus.

FIG. 9 is a timing chart showing an operation timing of a single write transmission during a burst write transmission in the data transmission apparatus according to the first embodiment of the present invention.

FIG. 10 is a timing chart showing an operation timing of a read transmission during a burst write transmission in a conventional data transmission apparatus.

FIG. 11 is a timing chart showing an operation timing of a read transmission during a burst write transmission in the data transmission apparatus according to the second embodiment of the present invention.

FIG. 12 is a timing chart showing an operation timing of a shared processing of transmission data in a conventional data transfer apparatus.

FIG. 13 is a timing chart showing an operation timing of a shared processing of transmission data in the data transfer apparatus according to the third embodiment of the present invention.

FIG. 14 is a timing chart showing an operation timing of accessing an identical address in the data transfer apparatus according to the fourth embodiment of the present invention.

FIG. 15 is a timing chart showing an operation timing of accessing from an identical transmission source in the data transfer apparatus according to the fourth embodiment of the present invention.

### DETAILED DESCRIPTION OF THE PREFERRED EMBODIMENTS

Hereunder, preferable embodiments of the present invention will be described referring to the accompanying drawings.

### Embodiment 1

A first embodiment of the present invention will be described here below, based on the drawings.

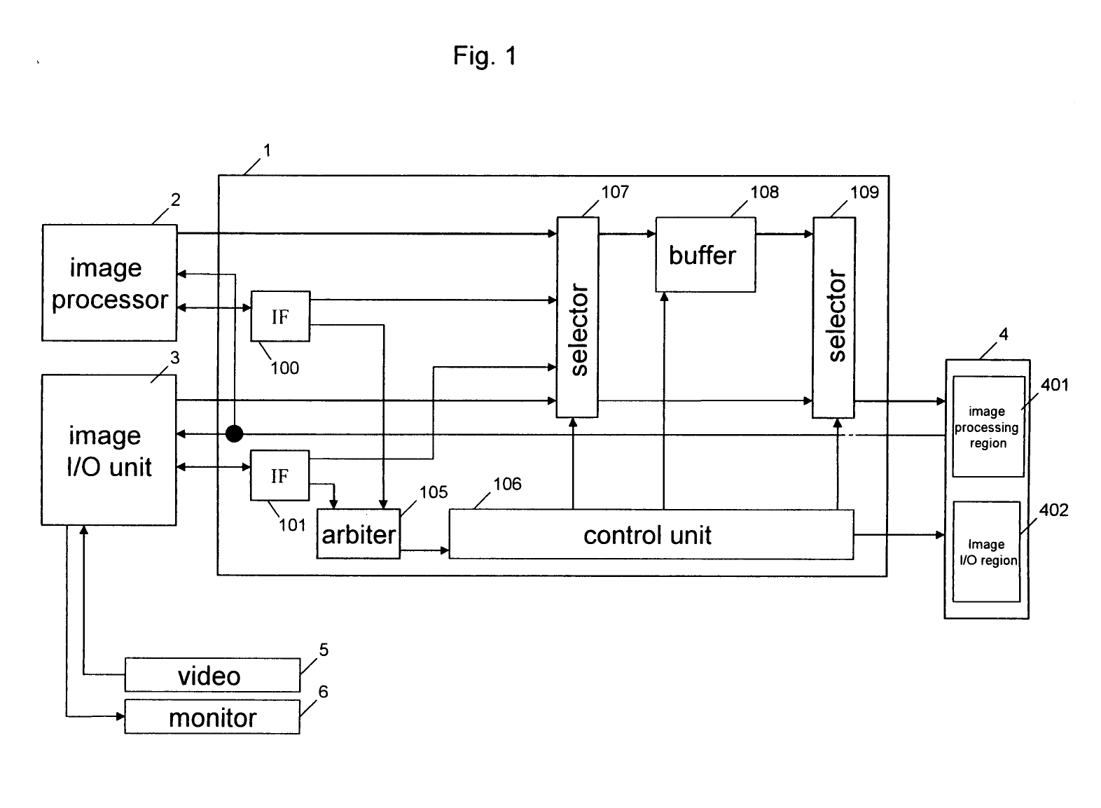

FIG. 1 is a block diagram showing a configuration of a data transfer apparatus according to the first embodiment of the present invention.

In FIG. 1, numerals 2 to 6 represent similar functional blocks to those of the prior art. In a data transfer apparatus 1, an interface 100 controls transmission data with the image processor 2. An interface 101 controls transmission data with the image processor 3. A selector 107 receives the transmission data from the image processor 2 and a transmission control signal from the interface 100 as a first input; the transmission data from the image I/O unit 3 and a transmission control signal from the interface 101 as a second input; and selectively outputs such transmission data to a buffer 108 and a selector 109 by a control signal of a control unit 106.

The buffer 108 temporarily retains transmission data output by the selector 107. The selector 109 receives an output of the buffer 108 as a first input and an output of the selector 107 as a second input, and selectively outputs the output of the buffer 108 and the output of the selector 107 by a control signal of the control unit 106. An arbiter 105 arbitrates between a transmission start request signal from the interface 100 and a transmission start request signal from the interface 101, and outputs to the control unit 106. The control unit 106 controls the selector 107, the buffer 108 and the selector 109 in accordance with the transmission request selected by the arbiter 105, and generates an access signal to a shared memory 4.

In the shared memory 4, a region 401 is utilized for image processing, and a region 402 is utilized for inputting/outputting an image.

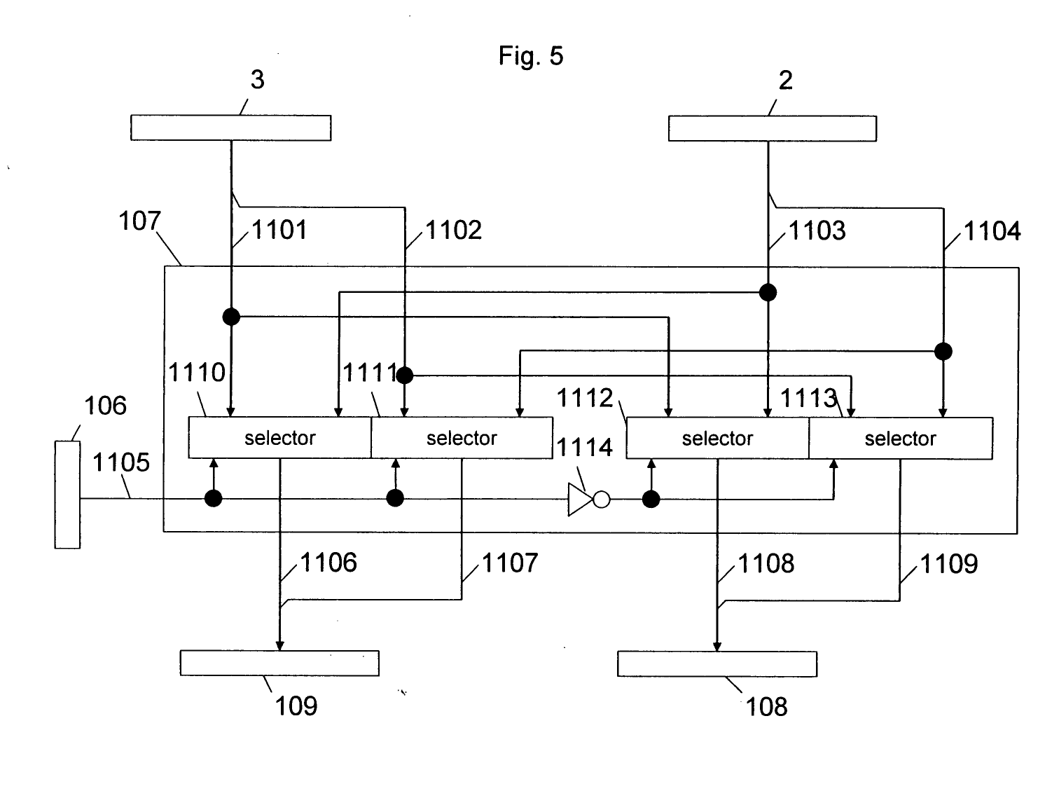

FIG. 5 is a block diagram showing an internal configuration of a selector (cross bus switch) 107.

In FIG. 5, numeral 1101 designates an address line output by the image I/O unit 3, and 1102 designates a data line thus output. Numeral 1103 designates an address line output by the image processor 2, and 1104 designates a data line thus output. Numeral 1106 designates an address line output to the selector 109, and 1107 designates a data line thus output. Numeral 1108 designates an address line output to the buffer 108, and 1109 designates a data line thus output. Numerals 1110, 1111, 1112, 1113 respectively represent a selector having two input terminals and an output terminal.

The selectors 1110, 1111 execute a selection based on an input of a control signal 1105 output by the control unit 106, and the selectors 1112, 1113 execute a selection based on an input of a signal inverted by an inverter 1114 from the control signal 1105 output by the control unit 106. Accordingly, when the selectors 1110, 1111 have selected the address line 1101 and the data line 1102 as the input, the selector 1112, 1113 selectively output the address line 1103 and the data line 1104.

On the contrary, when the selectors 1110, 1111 have selected the address line 1103 and the data line 1104 as the input, the selector 1112, 1113 selectively output the address line 1101 and the data line 1102.

Therefore, when the output of the image processor 2 is connected to the buffer 108, the output of the image I/O unit 3 is to be connected to the selector 109. On the contrary, when the output of the image processor 2 is connected to the the selector 109, the output of the image I/O unit 3 is to be connected to the buffer 108.

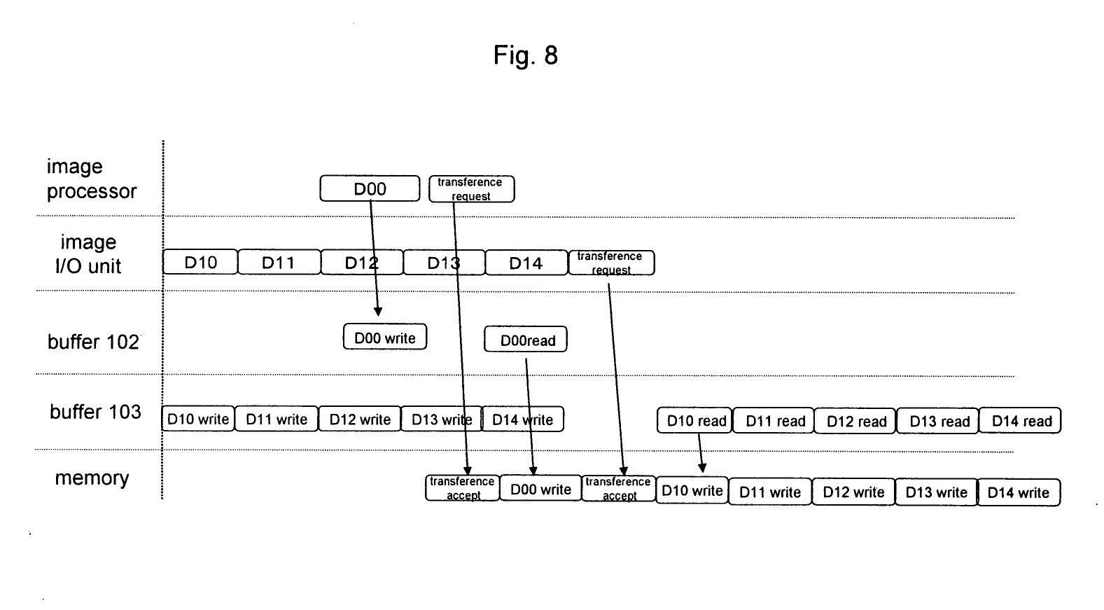

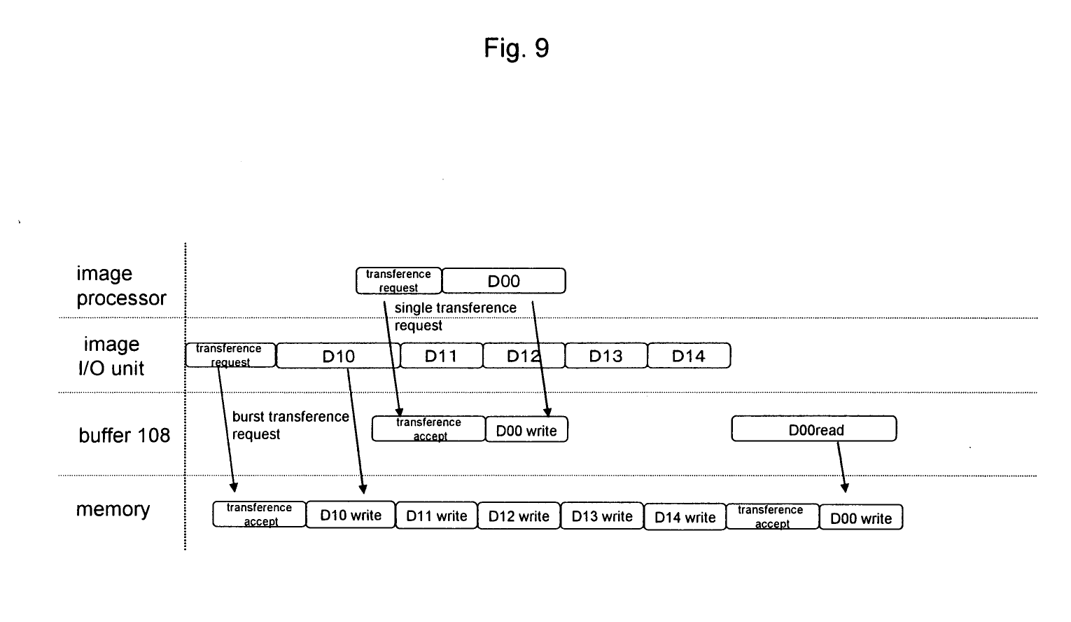

Referring to FIGS. 8 and 9, a data transmission timing according to the first embodiment of the present invention will be described. FIGS. 8 and 9 are showing an operation timing of a single write transmission by the image processor 2, during a burst write transmission by the image I/O unit 3. FIG. 8 shows the data transmission timing in a conventional data transfer apparatus, while FIG. 9 shows the data transmission timing in the data transfer apparatus according to the first embodiment of the present invention.

In FIG. 8, the image I/O unit 3 starts a data transmission to the shared memory 4 in a burst transmission mode. The image processor 2 starts a data transmission to the shared memory 4 in a single transmission mode, halfway of the burst transmission. Data D10 to D14 from the image I/O unit 3 are written in a buffer 103. Data D00 from the image processor 2 is written in a buffer 102. Then, the data retained in the buffer 102 and the buffer 103 are not transferred to the shared memory 4, until the image processor 2 and the image I/O unit 3 make a transmission request.

The interface 101 outputs a transmission request signal to the arbiter 105 based on a transmission request output from the image I/O unit 3, and the control unit 106 executes data transmission from the buffer 103 to the shared memory 4 (reading out from the buffer 103 and writing in the shared memory 4). Likewise, the interface 100 outputs a transmission request signal to the arbiter 105 based on a transmission request output from the image processor, and the control unit 106 executes data transmission from the buffer 102 to the shared memory 4 (reading out from the buffer 102 and writing in the shared memory 4). In the case where the timing of the transmission request signal output by the image processor 2 and that of the transmission request signal output by the image I/O unit 3 are overlapping, the arbiter 105 selects the transmission request signal according to a predetermined priority, and outputs the selected signal to the control unit 106.

In FIG. 9, when the image I/O unit 3 outputs a transmission request signal, the interface 101 detects that the transmission request signal from the image I/O unit 3 is for a burst transmission. The interface 101 then notifies the arbiter 105 that the request is from the image I/O unit 3 and that a burst transmission has been requested. The arbiter 105 notifies the control unit 106 to the same effect. The control unit 106 controls the selector 107 so as to connect the output of the image I/O unit 3 to the selector 109, because the transmission is made from the image I/O unit 3 and the mode is the burst transmission. At this stage, the control unit 106 controls the selector 109 so as to select the output of the selector 107. Further, the control unit 106 generates a control signal for the shared memory 4. That is how the burst transmission is executed. The burst transmission is sequentially executed as from the data D10.

A single transmission from the image processor 2 is started during the burst transmission from the image I/O unit 3. The interface 100 detects that the transmission request signal from the image processor 2 is for a single transmission. The interface 100 then notifies the arbiter 105 that the request is from the image processor 2 and that a single transmission has been requested. The arbiter 105 does not arbitrate between the single transmission and the burst transmission, but just notifies the control unit 106 to the effect that the single transmission request has been output by the image processor 2. The control unit 106 controls the selector 107 so as to connect the output of the image processor 2 to the buffer 108. The control unit 106 further controls the buffer 108 so as to temporarily retain the single transmission data DOO. Then, when the burst transmission from the image I/O unit 3 has finished the control unit 106 controls the selector 109 and generates a control signal for the shared memory 4. By this control signal, the data retained in the buffer 108 is transferred to the shared memory 4.

As described above, the data transfer apparatus is designed such that the buffer 108 retains the single transmission data, and that the single transmission and the burst transmission can be processed in parallel, in the case where the single transmission and the burst transmission are mixed in the access. Accordingly, despite that a hardware scale is reduced compared with a conventional configuration in which a buffer exclusively for image processing and exclusively for image I/O are respectively provided, a latency performance of an access in a data transmission between the image processor 2/image I/O unit 3 and the data transfer apparatus 1 can be maintained. Focusing further on a latency in a transmission between the image processor 2/image I/O unit 3 and the shared memory 4, the data transfer apparatus according to the first embodiment of the present invention offers a higher performance than the data transfer apparatus according to the prior art.

### Embodiment 2

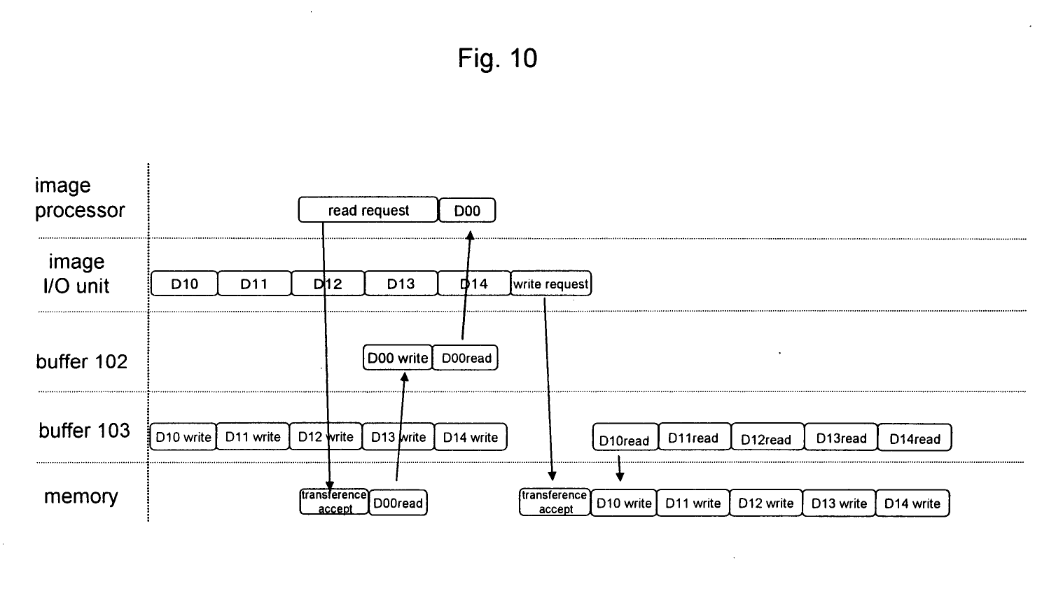

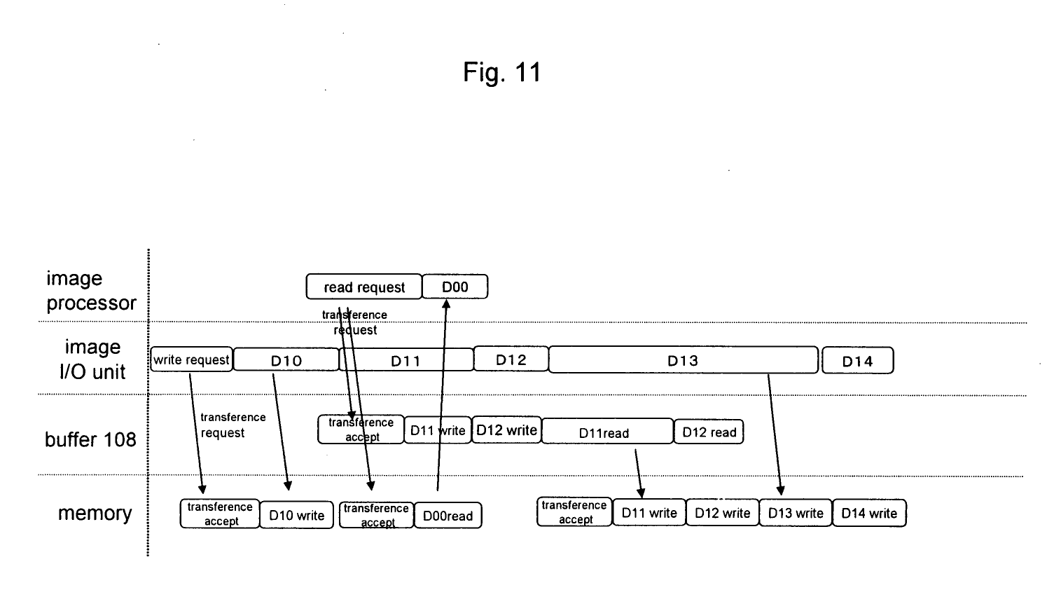

Referring to FIGS. 10 and 11, a data transmission timing in a data transfer apparatus according to the second embodiment will be described. FIGS. 10 and 11 are showing an operation timing of a read transmission by the image processor 2, during a burst write transmission by the image I/O unit 3. FIG. 10 shows the data transmission timing in a conventional data transfer apparatus, while FIG. 11 shows the data transmission timing in the data transfer apparatus according to the first embodiment of the present invention. Configuration of the data transfer apparatus is similar to that in the first embodiment.

In the data transfer apparatus according to the prior art, the image I/O unit 3 starts a data transmission to the shared memory 4 in a burst transmission mode in FIG. 10. The image processor 2 outputs a read request to the shared memory 4, halfway of the burst transmission. The data D10 to D14 from the image I/O unit 3 are written in the buffer 103. The data D00 from the shared memory 4 is written in the buffer 102 by the control unit 106, and then transferred to the image processor 2. The data retained in the buffer 103 by the image I/O unit 3 is not transferred to the shared memory 4, until the image I/O unit 3 makes a transmission request. The interface 101 outputs a transmission request signal to the arbiter 105 based on a transmission request output by the image I/O unit 3, and the control unit 106 executes data transmission from the buffer 103 to the shared memory 4 (reading out from the buffer 103 and writing in the shared memory 4).

On the other hand, in the data transfer apparatus according to the present invention, when the image I/O unit 3 outputs a transmission request, the interface 101 detects that the transmission request signal from the image I/O unit 3 is for a burst transmission, as in FIG. 11. The interface 101 then notifies the arbiter 105 that the request is from the image I/O unit 3 and that a burst transmission has been requested. The arbiter 105 notifies the control unit 106 to the same effect. The control unit 106 controls the selector 107 so as to connect the output of the image I/O unit 3 to the selector 109, because the transmission is made from the image I/O unit 3 and the mode is the burst transmission. The control unit 106 also controls the selector 109 so as to select the output of the selector 107. Further, the control unit 106 generates a control signal for the shared memory 4. That is how the burst transmission is executed. The burst transmission is sequentially executed as from the data D10.

The transmission from the image processor 2 is started during the burst transmission. The interface 100 detects that the transmission request from the image processor 2 is for a read transmission. The interface 100 then notifies the arbiter 105 that the request is from the image processor 2 and that a read transmission has been requested. The arbiter 105 notifies the control unit 106 to the effect that the read transmission request has been output by the image processor 2. The control unit 106 controls the selector 107 so as to connect the output of the image I/O unit 3 to the buffer 108. The control unit 106 further controls the buffer 108 so as to temporarily retain the burst transmission data from D11 sequentially. At this stage, the read transmission is executed from the shared memory 4 to the image processor 2. Then, when the read transmission from the shared memory 4 to the image processor 2 has finished, the control unit 106 controls the selector 109 and generates a control signal for the shared memory 4. By this control signal, the data retained in the buffer 108 (D11, D12) is transferred to the shared memory 4. The burst transmission data from D13 is transferred to the shared memory through the selector 107, 109, in the same manner as before the input of the read transmission request.

As described above, the data transfer apparatus is designed such that the buffer 108 retains the burst transmission data, and that the read transmission and the burst transmission can be processed in parallel, in the case where the read transmission and the burst transmission are mixed in the access. Accordingly, compared with a conventional configuration in which a buffer exclusively for image processing and exclusively for image I/O are respectively provided, a latency performance of an access in a data transmission between the image processor 2/image I/O unit 3 and the data transfer apparatus 1 can be better maintained.

### Embodiment 3

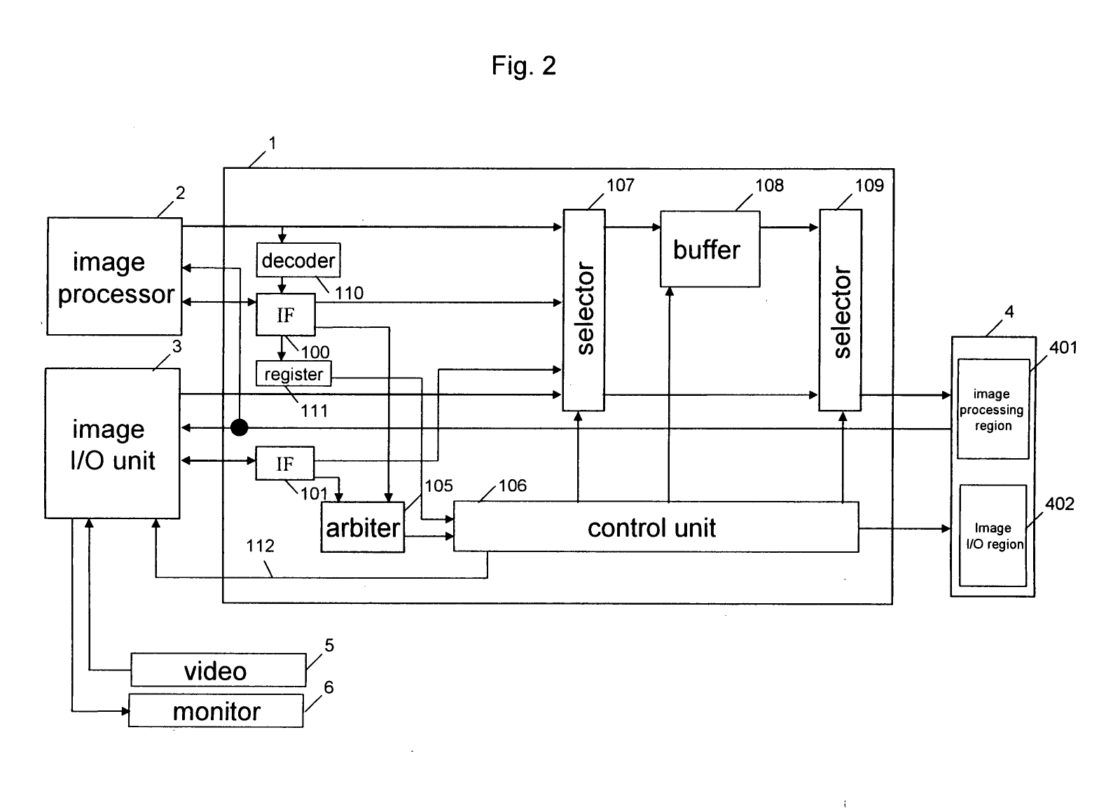

FIG. 2 is a block diagram showing a configuration of a data transfer apparatus according to the third embodiment of the present invention.

In FIG. 2, numeral 110 designates an address decoder, 111 a buffer transmission request register, 112 a buffer transmission finish notice interrupt signal. Other constituents have similar functions to those shown in FIG. 1.

From the viewpoint of the image processor 2, an address to the shared memory 4 and an address to the buffer transmission request register 111 are mapped in the data transfer apparatus 1. An access to the buffer transmission request register 111 can be made by decoding of the access address from the image processor 2 by the address decoder 110. When the access to the buffer transmission request register 111 is started, the control unit 106 causes the buffer 108 to transfer retained data to the shared memory 4, and controls the interface 100 not to finish the buffer transmission request register access until the transmission is completed. Accordingly, the interface 100 outputs await signal to the image processor 2. Since the output from the buffer transmission request register 111 does not have to be writing data to the register, the interface 100 and the control unit 106 may communicate so as to generate the wait signal to the image processor 2, without physically providing the register. The buffer transmission finish notice interrupt signal 112 is output from the control unit 106 to the image I/O unit 3, when the buffer transmission has been completed.

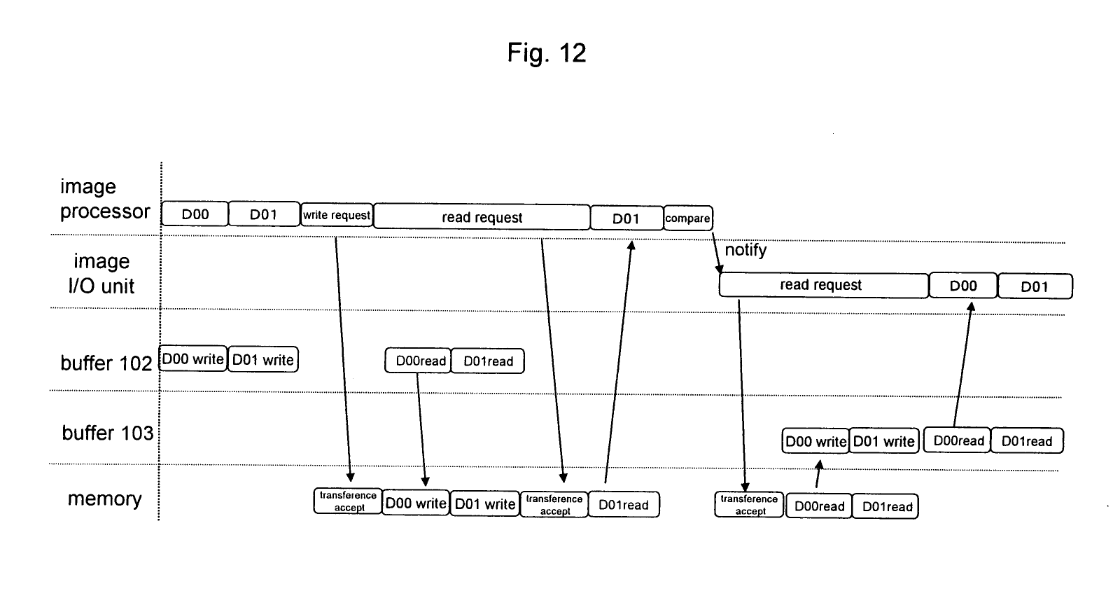

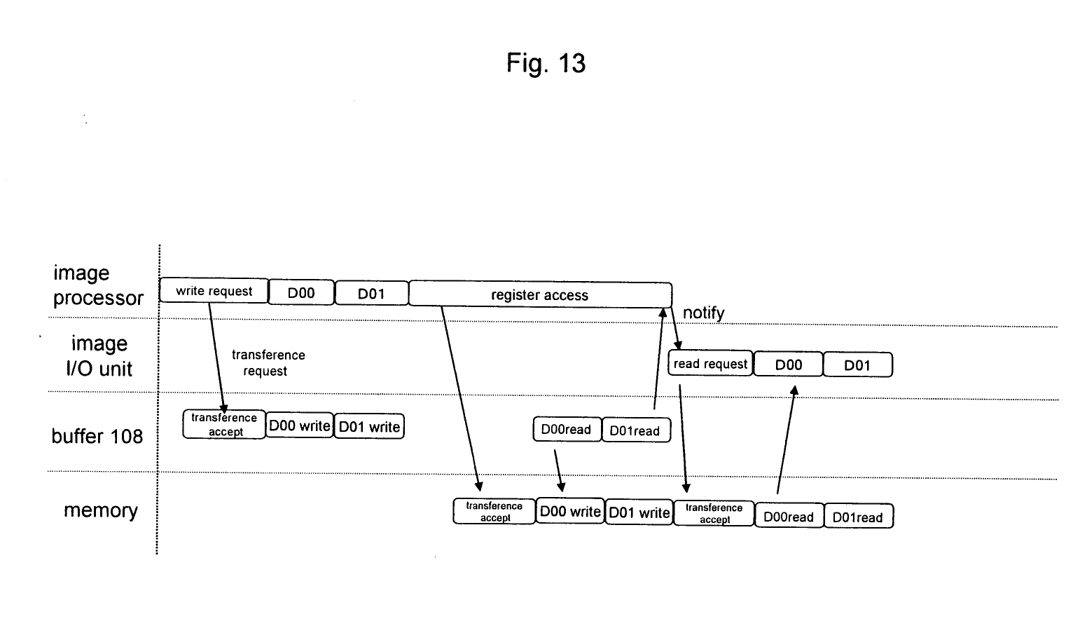

Referring to FIGS. 12 and 13, a data transmission timing in a data transfer apparatus according to the third embodiment will be described. FIGS. 12 and 13 show a case where the image I/O unit 3 reads out from the shared memory 4 the data transferred from the image processor 2 to the shared memory 4. FIG. 12 shows the data transmission timing in a conventional data transfer apparatus, while FIG. 13 shows the data transmission timing in the data transfer apparatus according to the first embodiment of the present invention.

In FIG. 12, the image processor 2 transfers data for the shared memory 4 to the buffer 102, and then outputs a write request from the buffer 102 to the shared memory 4. However, though the write request has been output, the transmission to the shared memory 4 is not fully assured. For example, a burst transmission from the image I/O unit 3 may still be continuing. Therefore, the image processor 2 reads data that was previously written, and checks whether the writing in the shared memory has been completed through a comparison of the read data and the data previously written. After confirming that the data transmission to the shared memory 4 has been completed, the image processor 2 notifies the image I/O unit 3 to the effect that the data is available in the shared memory 4, so that the image I/O unit 3 makes a read request to the shared memory 4.

In FIG. 13, the image processor 2 executes a data transmission to the shared memory 4, and the starts an access to the buffer transmission request register address. In response to the start of the access to the buffer transmission request register 111, the control unit 106 starts a data transmission to the shared memory 4 in the case where data is retained in the buffer 108, and notifies the interface 100 upon completing the data transmission. Accordingly, the interface 100 finishes the buffer transmission request register access with the image processor 2.

Then the control unit 106 activates the buffer transmission finish notice interrupt signal 112 so as to notify the image I/O unit 3 to the effect that the data exists in the shared memory 4. In response thereto, the image I/O unit 3 makes a read request to the shared memory 4.

As described above, when the image processor 2 and the image I/O unit 3 share the data to be transferred, a control is executed such that the data transmission is completed during the access period from the image processor 2 to the buffer transmission request register 111 so as to cause the buffer 108 to transfer the retained data to the shared memory, which eliminates the need to make a read access for confirmation of the memory data as is the case with the configuration of the prior art. Consequently, it is no longer necessary to read out the data from the shared memory for confirmation of the memory data, and to thereby make a bandwidth of the memory connection line effective.

Meanwhile, it is not imperative to physically provide the buffer transmission request register 111. In other words, the data transfer apparatus may be configured such that the address decoder 110 detects a specific address, and notifies the interface 100 that the specific address has been detected, so that the interface 100 directly communicates with the control unit 106.

### Embodiment 4

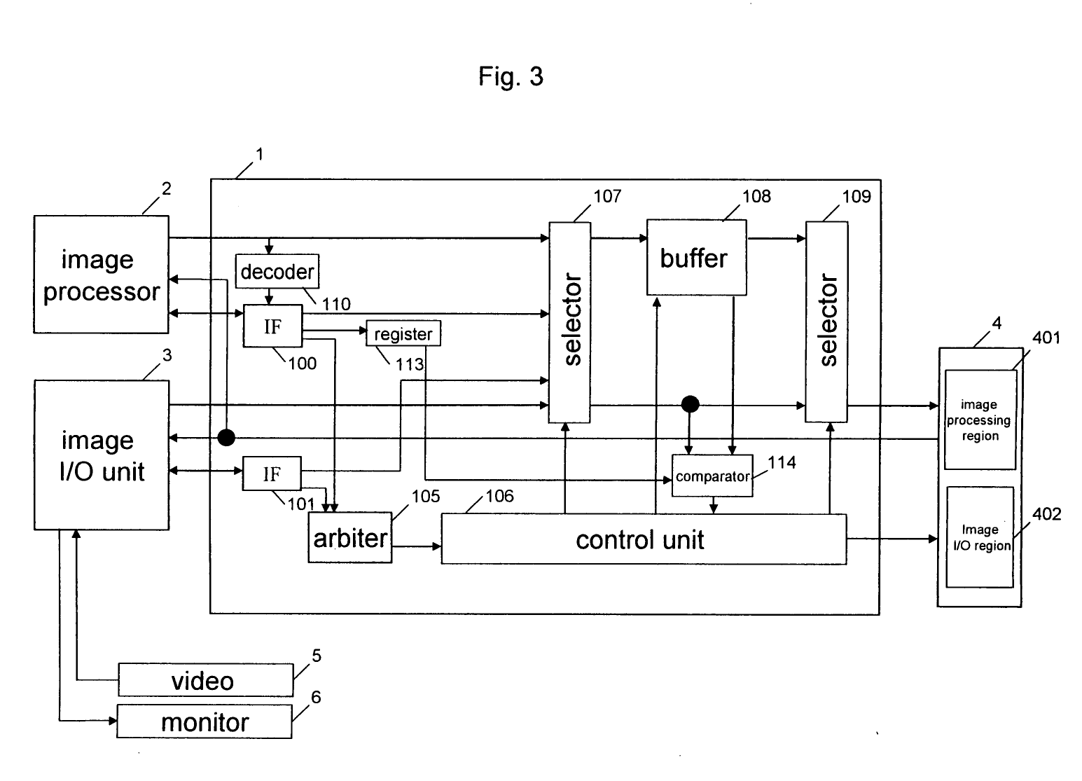

FIG. 3 is a block diagram showing a configuration of a data transfer apparatus according to a fourth embodiment of the present invention.

In FIG. 3, numeral 114 indicates a comparator unit, which compares a transmission address in a transmission request and a transmission address of data retained the buffer 108 when the image processor 2 or the image I/O unit 3 has made the transmission request. Numeral 113 indicates a register for setting a width of the address to be compared. A match detection is executed by comparing a part or the whole of the addresses with the register 113.

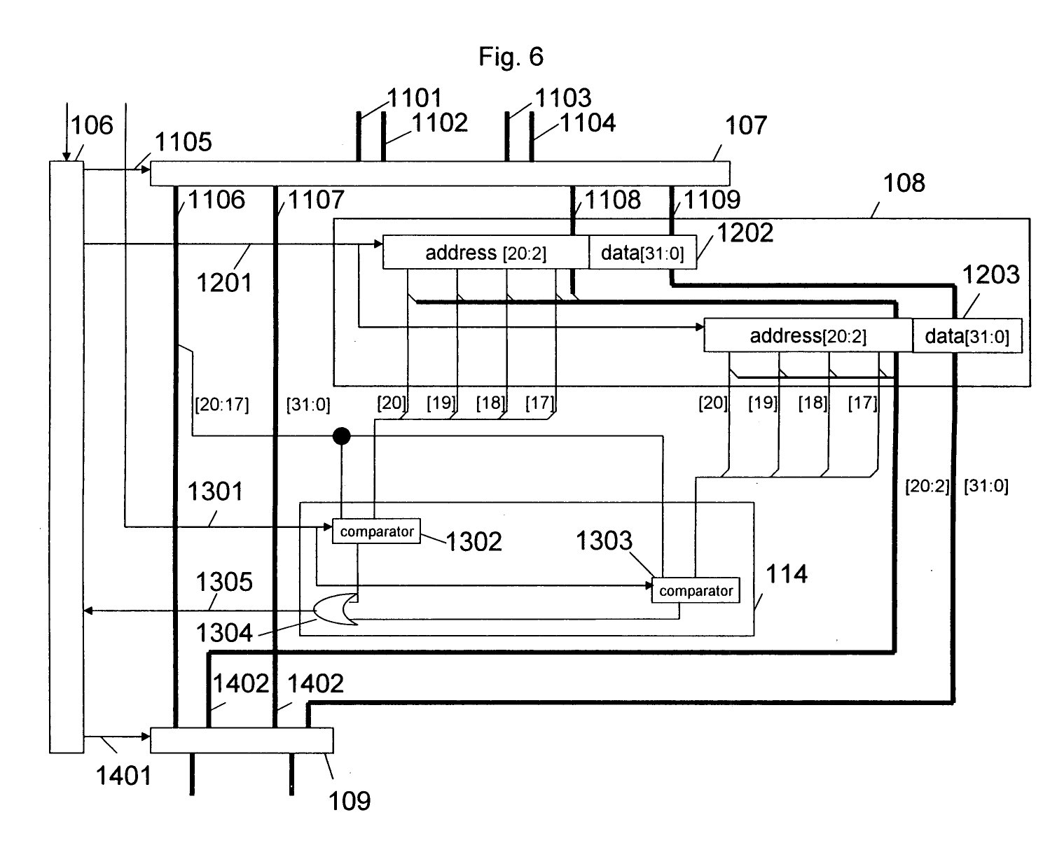

FIG. 6 is a block diagram showing an internal configuration of a buffer 108 and a comparator unit 114. In FIG. 6, the buffer 108 is connected so as to perform on a FIFO (First in, first out) basis, and includes internal buffers 1202, 1203. The transmission data is sequentially retained in the buffer 108 in a pair with the transmission address. The comparator unit 114 is constituted of comparators 1302, 1303, to which the address field of the internal buffers 1202, 1203 is to be input.

The comparators 1302, 1303 compare an address field value (transmission address) of the internal buffers 1202, 1203 and a value of the address output line 1106 (transmission address) of the selector 107 to be selectively output, when the image processor 2 or the image I/O unit 3 makes a transmission request, and generate an OR of all comparison results in a logic circuit 1304, to then notify the same to the control unit 106 in a form of a control signal 1305. The control unit 106, based on the comparison result, selectively outputs the output data of the selector 107 in the case where the transmission addresses are different, and controls the selector 109 so as to selectively output the output data in the buffer 108 when the addresses match. The control unit 106 also outputs the data to the buffer 108 with a control signal 1201, and then moves the data from the internal buffer 1202 to the internal buffer 1203. Meanwhile, a similar control is executed when retaining an identification information of a functional unit for specifying a transmission request source of the transmission data, instead of the address. Also, the buffer 108 may be constituted of a plurality of blocks, each of which includes a plurality of internal buffers, so that one of the blocks is designated according to a transmission request address.

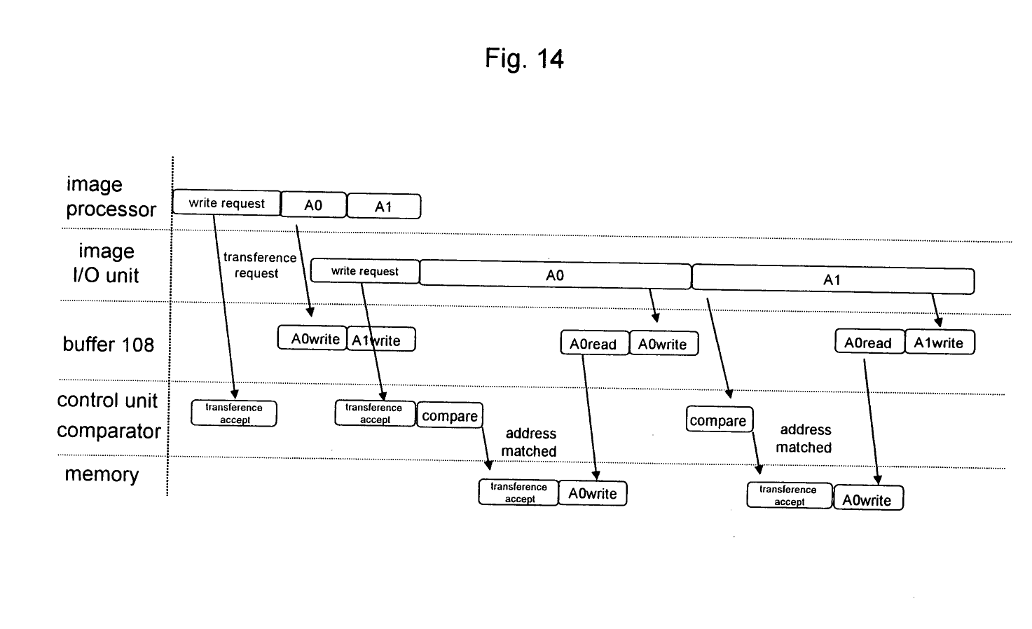

FIG. 14 is a timing chart showing a transmission timing when executing the address comparison. As shown therein, when the image I/O unit 3 has made a transmission request accompanied with a transmission address of A0 under a state that transmission data including transmission addresses of A0, A1 transferred from the image processor 2 is retained in the buffer 108, the following operation is carried out. The comparator unit 114 compares the addresses. Since the addresses match each other, the data of the transmission address A0 retained in the buffer 108 is transferred with priority to the shared memory 4. Thereafter, the transmission data (including the transmission address A0) from the image I/O unit 3 is retained in the buffer 108. In the case where a transmission request including the transmission address A1 has been continuously made, the addresses are compared. Here, since the addresses match each other, the data of the transmission address A1 retained in the buffer 108 is transferred with priority to the shared memory 4. Thereafter, the transmission data (including the transmission address A1) from the image I/O unit 3 is retained in the buffer 108.

Meanwhile, the foregoing transmission operation is based on the assumption that the control unit 106 controls the output of the selector 107 so as to output the transmission address of the transmission data being requested to the address line 1106, and switches the address to the address line 1108 for writing in the buffer 108 in the case where the comparison has proved a matching. However, in the case where the comparison has resulted in matching, the transmission of the data including the transmission address A0 from the buffer 108 to the shared memory 4 may be followed by the transmission of the data with the transmission address of A0 currently being requested for transmission, without writing in the buffer 108.

As described above, a transmission address is retained in the buffer 108 together with the transmission data, so that a transmission address retained in the buffer 108 and the transmission address of the data currently being requested for transmission are compared, and a transmission control is executed according to the comparison result. As a result, chronological sequentiality can be assured with respect to the transmission of the data retained in the buffer to the shared memory 4 and to the transmission of the data currently being requested for transmission to the shared memory 4.

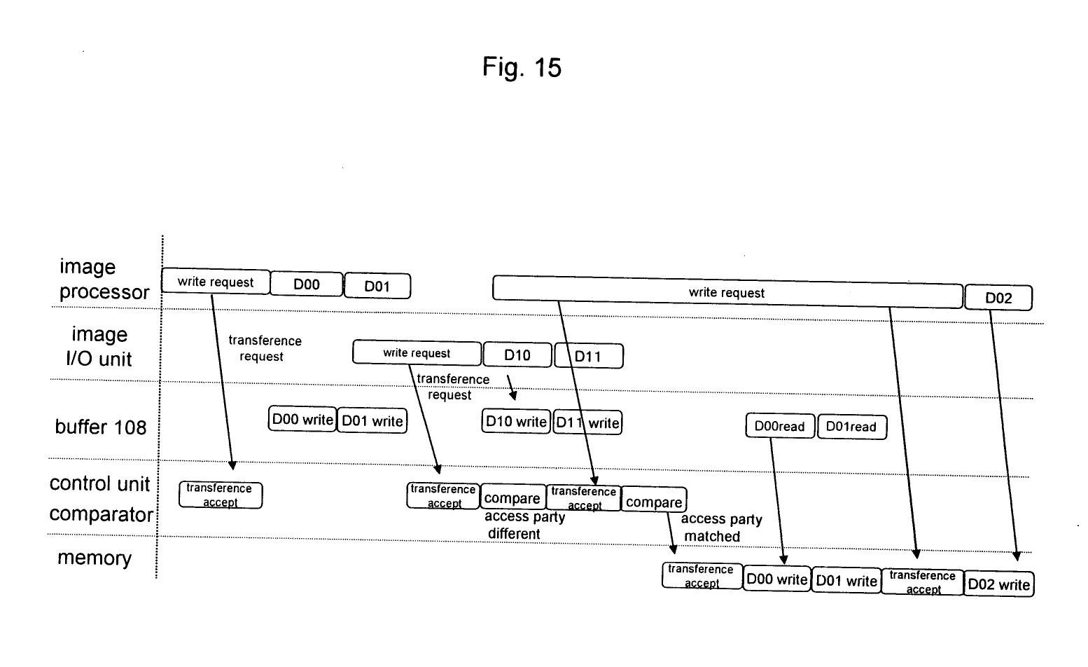

FIG. 15 is a timing chart showing a transmission timing when executing comparison of the transmission request source. As shown therein, when the image I/O unit 3 has made a transmission request of the data D10, D11, under a state that transmission data D00, D01 transferred from the image processor 2 are retained in the buffer 108, the following operation is carried out. The comparator unit 114 compares the transmission request source. Here, since the transmission source of the transmission data D00, D01 and the transmission source of the transmission data D10, D11 are different, the transmission data D10, D11 are transferred to the buffer 108. Then the comparator unit 114 compares the transmission request sources, in the case where the image processor 2 has made a transmission request of the transmission data D02 at the same time when the transmission data D10, D11 are being transferred to the buffer 108. Here, the transmission source of the transmission data D00, D01 retained in the buffer 108 matches the transmission source of the transmission data D02. Accordingly, the data D00, D01 retained in the buffer 108 are transferred with priority to the shared memory 4. In the case where the image processor 2 has a higher priority between the transmission requests of the image processor 2 and of the image I/O unit 3, the transmission data D00, D01 are transferred to the shared memory 4, after which the transmission data D02 is transferred to the shared memory 4.

As described above, information for identifying a transmission request source is retained in the buffer 108 together with the transmission data, so that the information for identifying a transmission request source retained in the buffer 108 and the transmission request source of the data currently being requested for transmission are compared, and a transmission control is executed according to the comparison result. As a result, chronological sequentiality under a state that the transmission request sources are identical can be assured, with respect to the transmission of the data retained in the buffer 108 to the shared memory 4 and to the transmission of the data currently being requested for transmission to the shared memory 4, and therefore transmission performance from a specific transmission request source to the shared memory 4 can be upgraded.

### Embodiment 5

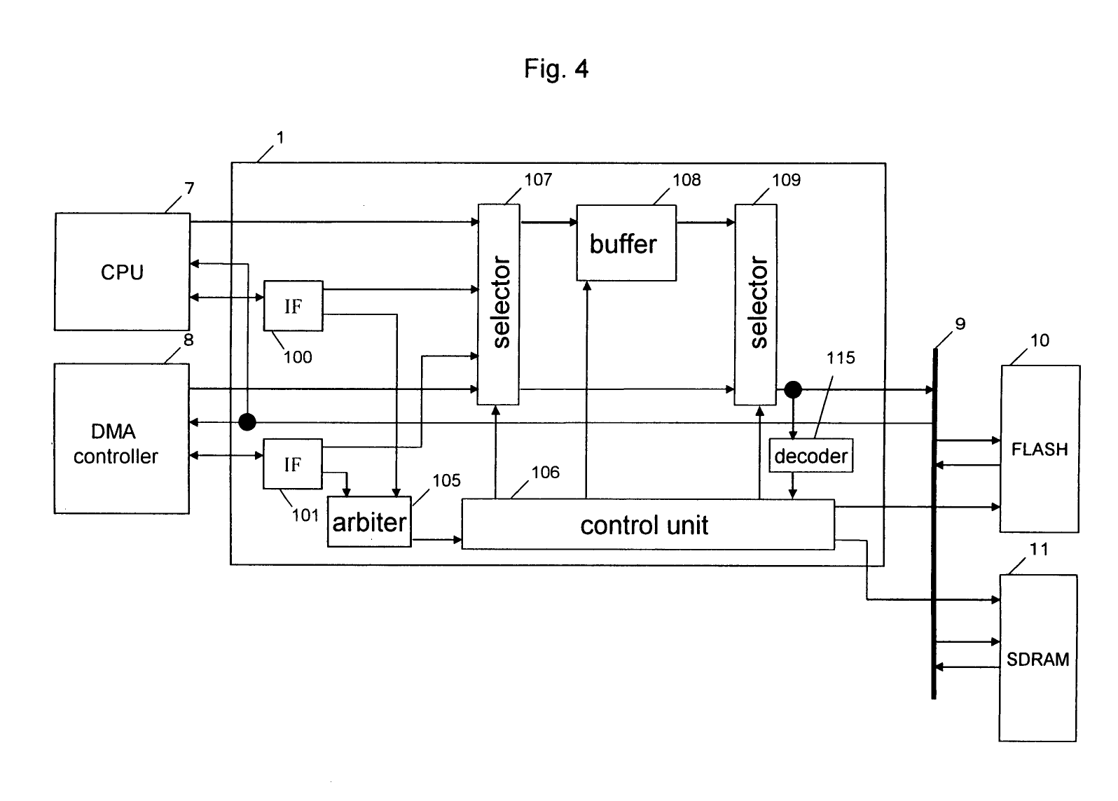

FIG. 4 is a block diagram showing a configuration of a data transfer apparatus according to a fifth embodiment of the present invention.

In FIG. 4, numeral 7 designates a CPU, 8 a DMA controller, 9 a system bus, 10 a flash ROM, 11 an SDRAM, and 115 designates an address decoder.

The data transfer apparatus 1 is a bus controller in which the CPU 7 and the DMA controller 8 act as masters, and the flash ROM 10 and the SDRAM 11 serve as slaves. The data transfer apparatus 1 divides the slaves into a plurality of regions.

The address decoder 115 decodes a transmission address selected by the selector 109, and outputs a region identifying result to the control unit 106. The control unit 106 outputs a ROM control signal in the case where the access is to be made to a region mapped in the flash ROM 10, and outputs an SDRAM control signal in the case where the access is to be made to a region mapped in the SDRAM 11.

The CPU 7 makes access to the flash ROM 10 in a unit of several words along with the cashing operation, and to the SDRAM 11 in a unit of one word.

The DMA controller 8 makes access to the SDRAM 11 in a unit of a transmission buffer size of the DMA controller 8.

Here, while a case where the control unit 106 generates a control signal for the slave device is described above, similar process is carried out in the case where a ROM control signal generating unit or an SDRAM control signal generating unit is separately provided.

As described above, the data transfer apparatus 1 can be applied to a broader range of systems, by adding the address decoder 115 to the output terminal of the transmission data and thereby switching the transmission mode for each address region.

### Industrial Applicability

The data transfer apparatus according to the present invention is applicable to data transmission between a plurality of functional units and a shared resource to be accessed in common, in which it is required to optimize a hardware scale of a buffer and improve working efficiency of the buffer, to thereby achieve a high-speed access between the plurality of functional units and a shared resource to be accessed in common.

1. A data transfer apparatus which receives an input of transmission data output by a plurality of functional units and outputs the transmission data to a shared resource to be accessed in common by said plurality of functional units, comprising:
a buffer;
first data selecting means which selects the data output by said plurality of functional units and outputs the data to said buffer;
second data selecting means which selectively outputs the data output by said plurality of functional units and the data output by said buffer; and
data transmission control means which outputs the data of said second data selecting means and transfers the data to said shared resource.

2. The data transfer apparatus as set forth in claim 1, wherein, when said second data selecting means is selectively outputting the data from a functional unit among said plurality of functional units, said first data selecting means selectively outputs to said buffer the data from another functional unit than that from which said second data selecting means is selectively outputting the data among said plurality of functional units.

3. The data transfer apparatus as set forth in claim 1 or 2, wherein, when transferring only data of a minimum unit word per data transmission cycle from said functional unit, said first data selecting means selectively outputs the data of said functional unit to said buffer.

4. The data transfer apparatus as set forth in claim 1 or 2, wherein, when executing both a data transmission only carrying the data of a minimum unit word per data transmission cycle from one of said plurality of functional units, and a data transmission carrying the data of a plurality of words per data transmission cycle from another of said plurality of functional units, said first data selecting means selectively outputs the data related to the transmission only carrying the data of a minimum unit word, to said buffer with priority.

5. The data transfer apparatus as set forth in claim 1 or 2,
wherein said data transmission control means controls the data transmission from said second data selecting means to said shared resource, as well as the data transmission from said shared resource to said plurality of functional units; and
said first data selecting means selectively outputs to said buffer the data transferred from said plurality of functional units requesting the data transmission to said shared resource, and said data transmission control means transfers the data from said shared resource with priority, when said plurality of functional units respectively request data transmission from said shared resource as well as data transmission to said shared resource.

6. The data transfer apparatus as set forth in claim 1 or 2, further comprising a first register accessible from said plurality of functional units,
wherein, when one of said functional units starts an access to said first register, said data transmission control means detects the start of the access to said first register, and controls such that the data retained in said buffer is transferred to said shared resource with priority, and that the access to said first register is finished once the transmission of the data retained in said buffer has finished.

7. The data transfer apparatus as set forth in claim 6, further comprising an interrupt signal generating means, which activates an interrupt signal to another functional unit than that which has made the register access, once the access to said first register has finished.

8. The data transfer apparatus as set forth in claim 1 or 2, said buffer retaining at least one transmission address in a pair with the transmission data, further comprising a comparator which compares a transmission address retained in said buffer and the transmission address requested by a functional unit, so as to output a match information,
wherein said data transmission control means further inputs the match information, so as to transfer the data from said buffer to said shared resource with priority until the match information is no longer active, in the case where said functional unit is requesting either the data transmission from said shared resource or the data transmission to said shared resource and the match information is active.

9. The data transfer apparatus as set forth in claim 8, further comprising a second register which determines a selection of a part of the transmission address,
wherein said comparator compares the part of the address and the transmission address requested by said functional unit.

10. The data transfer apparatus as set forth in claim 1 or 2, said buffer retaining a first identification information of said functional unit that has output the transmission data in a pair with the transmission data, further comprising a comparator which compares the first identification information retained in said buffer and a second identification information of said functional unit requesting the transmission so as to output a match information,
wherein said data transmission control means further inputs the match information, so as to transfer the data from said buffer to said shared resource with priority until the match information is no longer active, in the case where said functional unit is requesting either the data transmission from said shared resource or the data transmission to said shared resource and the match information is active.

11. The data transfer apparatus as set forth in claim 1 or 2, comprising a plurality of shared resources, which are respectively mapped in a different address region; and
address decoding means which decodes the transmission address output by said second data selecting means,
wherein said data transmission control means controls the data transmission to a shared resource designated by said address decoding means, among said plurality of shared resources.
